(19) United States
(12) Patent Application Publication
(10) Pub. No.: US 2004/0026411 A1
(43) Pub. Date: Feb. 12, 2004

(54) Electric heating body

(75) Inventors: Wolfgang Mucke, Berlin (DE); Bert Peters, Berlin (DE)

Correspondence Address: John T. Winburn, BSH Home Appliances Corporation, 120 Bosch Blvd, New Bern, NC, 28562, US

(73) Assignee: BSH Bosch und Siemens Hausgerate GmbH, Munich (DE)

(21) Appl. No.: 10/422,224

(22) Filed: Apr. 24, 2003

(30) Foreign Application Priority Data
Oct. 27, 2000 (DE) 10053415.5

(51) Int. Cl. H05B 3/16

(52) U.S. Cl. 219/543

(57) ABSTRACT

The electric heating body is comprised of a heat distribution plate (3) that conducts heat well, of at least one heat conductor (2) consisting of a thick film conductor track, which is applied to one side of the heat distribution plate and which leaves the at least one area (6) of the heat distribution plate (3) uncovered, and of a connection element (4) for the galvanic connection to the conductor track ends. The aim of the invention is to measure the temperature of the medium to be heated, in a manner that is both continuous and as instantaneous as possible, during running operation of the thick-film heater and to avoid the provision of an additional opening in the container. To these ends, a temperature-dependent resistor (9) consisting of a thick-film conductor track (8, 9), which is applied to the same side of the heat distribution plate (3) as the heat conductor (2) and which is made of a material having an absolute value for the temperature coefficients that is large enough to be evaluated, is provided on said area (6) in a position that, like the heat conductor (2), is electrically insulated.

The invention relates to an electrical heating body consisting of a heat distribution plate that conducts heat well, of at least one heat conductor consisting of a thick film conductor track which is applied to one side of the heat distribution plate and which leaves the at least one part of the heat distribution plate uncovered, and of a connection element for the galvanic connection to the conductor track ends, in accordance with the preamble to claim 1.

In addition to a variety of known heating plates with tubular heating bodies in close contact from the thermal technology point of view, for the heating of mostly liquid media in water-carrying domestic appliance such as washing machines or dishwashers arrangements known as thick-film heaters are known, in which, with the intermediate insertion of a mineral insulation layer, today made mainly of silicate glass, flat heat conductor strips are applied as thick layers on a heat distribution plate with good thermal conductivity, mostly made of metal. The metallic plate is placed into a cut-out of the medium container and is in direct contact with the medium.

This has the advantage that the heating energy given off by the thick-film conductor tracks is transferred onto the medium almost directly and free of any loss. This reduces the energy expenditure and investment required. In addition, heating bodies which are constructed flat in this way, such as thick-film heating elements, do not require their own structural space, such as a tubular heating body does, as a result of which a substantial volume of water can be saved.

In order to monitor the temperature of the medium which is to be heated (water or lye), with the use of both tubular heating bodies as well as thick-film heating elements, use is made of electromechanical or electronic temperature sensors, which are located at any apparently suitable place in the medium container. In most cases, in order to achieve this a breakthrough must be provided in the container, which from the production engineering point of view is an elaborate procedure, and is questionable from the technical safety point of view because of problems with sealing.

The invention is based on the problem of ensuring a continuous and, as far as possible, delay free measurement of the temperature of the medium which is to be heated, with the ongoing operation of the thick-film heating. In this situation it is desirable that no further breakthrough in the container needs to be provided for the measurement of the medium temperature.

According to the invention, this problem is resolved with an electrical heating body of the type referred to in the preamble in such a way that, on the area, a temperature-dependent resistor is provided which is formed from a thick-film conductor track located on the same side of the heat distribution plate as the heat conductor, made of a material with a sufficiently large absolute value for the temperature coefficient to be evaluated, located in a position which is electrically isolated and largely thermally isolatable from the heat conductor.

The integration according to the invention of the temperature sensor likewise in thick-film technology directly on the heat distribution plate has the advantage that the temperature of the medium is acquired immediately after it has been heated, without it being possible for a cooling process to set in. Because the thick-film heat conductor is connected to the heat distribution plate with especially good thermal effect, as a result of which a rapid transfer of the thermal energy takes place, which then in turn is transferred very rapidly to the medium, the thermal linking of a temperature-dependent resistor in thick-film technology in accordance with the invention in the same heat distribution plate is possible even in the proximity of the heat conductor, without any fear of substantial thermal coupling directly to the heat conductor. As a result, the temperature sensor has a better thermal coupling via the heat distribution plate to the heated liquid than the relatively distant heat conductor. The thermal link of the sensor to the nearest heat conductor via the heat distribution plate is also poorer, because for this the heat flow must run twice through the thermal insulation. Experience has therefore shown that a distance of a few millimetres between the sensor and the nearest heat conductor already provides for good thermal isolation.

It is true that a heat distribution plate can be used which is itself manufactured from electrically insulating material, in order for the heat conductor and sensor materials applied directly onto this plate to be galvanically separated from one another. However, electrical isolators in most cases are not particularly good heat conductors, so that the representation of the solution according to the invention with an electrically neutral material for the heat distribution plate does not succeed as well as with a material which is a good electrical and thermal conductor. Accordingly, in one especially advantageous embodiment of the invention the heat conductor and the temperature dependent resistor are galvanically isolated by a temperature resistant isolation from the heat distribution plate.

In addition, this galvanic isolation is represented in an advantageous manner by a silicate glass melt layer. From the production engineering point of view, this is not problematic and also provides very good resistance to stresses caused by sharp temperature differences and lye burdens.

If the heat distribution plate in a preferred embodiment of the invention is circular in shape, the heat conductor is likewise arranged circular about the centre in meander form, and the temperature-dependent resistor is arranged in the centre, then a design arrangement can be achieved with very good data for the temperature resistance and good thermal coupling and isolation properties.

To improve the lye resistance, which is nevertheless already good, it is of particular advantage if, according to one embodiment of the invention, the heat distribution plate is enclosed together with the heat conductor and the temperature-dependent resistor by a silicate glass melt layer.

In a particularly advantageous manner, a heating body with at least one of the foregoing features can be used with a washing machine or dishwasher, with a heating body for the lye arranged in the deepest area of a lye container.

The invention is explained in greater detail hereinafter on the basis of embodiments represented in the drawings. These shows:

FIG. 1A view of the surface of a heating body according to the invention, occupied by the heat conductors and a sensor arrangement,

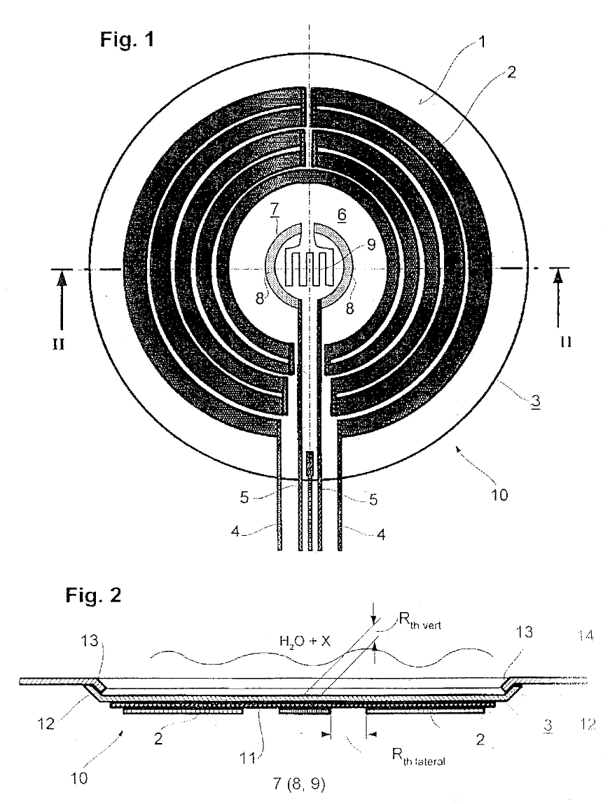

FIG. 2A view according to FIG. 1, with another sensor arrangement and with an electrical connection trough on a heating body according to the invention, and

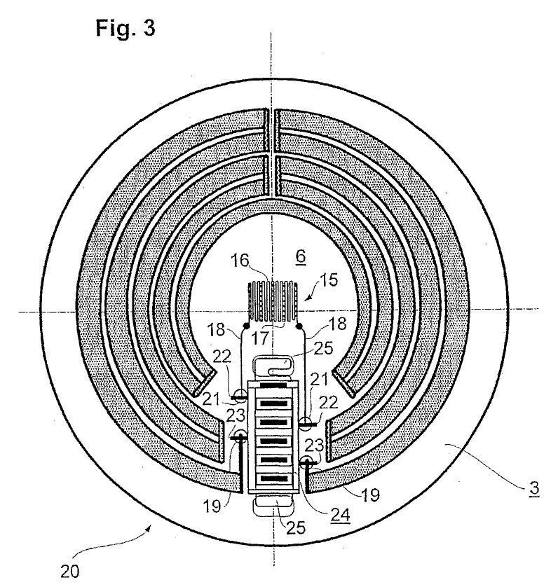

FIG. 3A section through the heating body along the section line II-II in FIG. 1.

The view onto the heating surface 1 of the heating body designed according to the invention in FIG. 1 shows a circular meandering course of the heat conductor 2, which are capable of being connected to a voltage source, not shown, via two connection lugs 4 projecting beyond the edge of the heat distribution plate 3. The meander changes of direction of the heat conductors are arranged in such a way that a channel remains free between them on the heat conductor surface 1 for the guiding of infeed and outfeed lines 5, likewise applied in thick-film technology, for a temperature sensor 7 applied on the small circular middle surface 6, also in thick-film technology. The temperature sensor consists of two semicircular infeed lines 8, surrounding a central area, which surrounds the actual thermal resistor 9, consisting of thick-film lines of a material with a sufficiently large absolute value for the temperature coefficient for the evaluation procedure. As a result, the thermal resistor 9 is better protected against thermal effects from the side.

Although the cover dimensions of the heat distribution plate 3, and the electrical conductors 2, 8 and 9 applied to it, are represented as exaggeratedly large in comparison with the diameter of the heating body 10, in order to illustrate the arrangement, it can already be seen from FIG. 2 that the thermal resistance R_{l vert} in the vertical direction between the temperature sensor 7 and the lye H₂O+X in contact directly on the upper face of the heat distribution plate 3 is perceptibly less than the thermal resistance R_{h lateral} between the temperature sensor 7 and the heat conductors 2 surrounding it.

For the electrical isolation between the metallic heat distribution plate 3 and the individual thick-film conductors 2, 8, and 9, use is made of a mineral layer 11, for preference a silicate glass melt layer. It is true that this has no, or very little, thermal resistance. However, because it is applied very thinly, which accords with the electrical isolation required, the thermal resistance can still be regarded as sufficiently small.

The peripheral area 12 of the heat distribution plate 3 is curved upwards and corresponds in its shape to an opposed peripheral area 13 of a corresponding cut-out in the lye container 14 of a washing machine, not shown.

The heating body 20 represented in FIG. 3 has a temperature sensor 15 of a different design to that in FIG. 1. Arranged between individual numbers of its conductor track folds 16 are temperature dependent resistance conductor strips 17, of which the temperature-dependent resistance values can be electrically registered. Both the ends of the heat conductors 2 as well as the connection leads 16 of the temperature sensor 15 are guided at contact points 19 and 21 above the isolating layer 11. These contact points 19 and 21 are galvanically connected by foot like connection lugs 22 and 23 of a measuring strip 24. Such a connection can be established by soldering or welding. In addition to this, the measuring strip 24 is also mechanically connected by feet 25 to the heat distribution plate 3 in the same manner.

Thanks to the design form according to FIG. 3, the electrical connection to the heating body can be provided in a simpler, mechanically more reliable, and more installation-friendly manner thanks to the circumstances of its installation area.

1. An electrical heating body consisting of a heat distribution plate (3) that conducts heat well, of at least one heat conductor (2) consisting of a thick-film conductor track which is applied to one side of the heat distribution plate and which leaves the at least one part of the heat distribution plate (3) uncovered, and of a connection element (4, 24) for the galvanic connection to the conductor track ends, characterised in that on the area (6) a temperature-dependent resistor (9, 16, 17), consisting of a thick-film conductor track (8, 9, 16) located on the same side of the heat distribution plate (3) as the heat conductor (2), made of a material with a sufficiently large absolute value for the temperature coefficient for the assessment, is provided for in a position which is electrically isolated like the heat conductor (2) and is largely thermally decoupled from the heat conductor (2).

2. The heating body according to claim 1, characterised in that the heat conductor (2) and the temperature-dependent resistor (9, 16, 17) are galvanically isolated by the heat distribution plate (3) by temperature resistant insulation (11).

3. The heating body according to claim 2, characterised in that the galvanic isolation is represented by a silicate glass melt layer.

4. The heating body according to one of claims 1 to 3, characterised in that the heat distribution plate (3) is circular in shape and the heat conductor (2) is likewise arranged in meander fashion circularly around the centre (6), and that the temperature-dependent resistor is arranged in the centre (6).

5. The heating body according to one of claims 2 to 4, characterised in that the heat distribution plate (3) is enclosed together with the heat conductor (3) and the temperature-dependent resistor (9, 16, 17) by a silicate glass melt layer.

6. A washing machine or dishwasher with a heating body for the lye arranged in the deepest part of a lye container, characterised in that the heating body is designed in accordance with one of claims 1 to 5.
